(19) United States
(12) Patent Application Publication
(10) Pub. No.: US 2024/0178363 A1
(43) Pub. Date: May 30, 2024

(54) Method for Stabilizing an Electrode Using a Functional Layer, the Electrode, and Applications Thereof

(71) Applicant: National Taiwan University of Science and Technology, Taipei (TW)

(72) Inventors: Bing-Joe Hwang, Taipei (TW); Sheng-Chiang Yang, Taipei (TW); Semaw Kebede Merso, Taipei (TW); Wei-Nien Su, Taipei (TW); She-Huang Wu, Taipei (TW)

(21) Appl. No.: 18/172,408

(22) Filed: Feb. 22, 2023

(30) Foreign Application Priority Data
Nov. 24, 2022 (TW) 111144947

(51) Int. Cl. H01M 4/04; H01M 4/139

(52) U.S. Cl. CPC H01M 4/0445; H01M 4/139

(57) ABSTRACT

The present invention provides a method for stabilizing an electrode using a functional layer, the electrode and applications thereof, which generates a beneficial electrolyte interface layer on the surface of the negative electrode after charging and discharging, and a protective buffer layer to form an alloy that facilitates the deposition of dense lithium on the negative current collector, significantly extending the life of the battery.

### FIELD OF THE INVENTION

The present invention is related to a method of stabilizing electrode, more particularly, a method for stabilizing electrode using a functional layer, and an electrode containing the functional layer and the application thereof.

The electrode containing the functional layer provided by the present invention is mainly applied to a negative current collector and its application on an anode-free battery, the main embodiments of which will be described in detail below. However, the functional layer and the method of stabilizing the electrode provided by the present invention are not limited to a single type of negative current collector, other related electrodes may also be included in the application of the present invention.

### BACKGROUND OF THE INVENTION

The conventional anode-free battery and a solid-state battery are prone to generate dendrite lithium on the negative electrode during charging and discharging, which causes the growth of the undesirable Solid Electrolyte Interface (SEI) and electrolyte side reactions that prevent the deposition of dense lithium on the negative electrode, resulting in a vicious cycle of consuming the lithium ions provided by the positive electrode, causing the decline of the electric capacity rapidly.

Hence, it is eager to have a solution that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve the problem that the negative electrode of anode-free battery and solid-state battery tend to generate lithium dendrite and undesirable solid electrolyte interface, which leads to rapid capacity loss, the present invention provides an electrode containing a functional layer and the method and application of stabilization, in order to improve or at least provide an alternative solution. The present invention provides a method for stabilizing an electrode using a functional layer comprising the steps of:
providing a battery comprising at least a positive electrode and a negative electrode in current/voltage communication;
attaching a functional layer precursor to at least a portion of the surface of the negative electrode, the functional layer precursor comprising a material with composition AₓB_{y} and/or a polymer, where x and y are positive integers, A is a lithiophilic metal or a lithiophilic metalloid, and B is an inorganic material;
charging the positive electrode and the negative electrode of the battery and forming a metal/alloy layer on the surface of the negative electrode corresponding to the surface of the functional layer precursor and the composition A of the functional layer precursor AₓB_{y}, also forming an electrolyte interface layer on the surface of the metal/alloy layer, B, and/or its alloy compound; and
discharging the positive electrode and the negative electrode of the battery so that the metal/alloy layer is transformed into a functional layer and the electrolyte interface layer, and obtains the electrode that is stabilized by using the functional layer.

In accordance with the second aspect of the present invention, the present invention further provides an electrode containing the aforementioned functional layer and an anode-free battery comprising the electrode having the functional layer made corresponded to the aforementioned method.

In accordance, the present invention has the following advantages and beneficial effects:

The present invention provides a multi-functional layer applied onto the negative electrode current collector of the battery, which generates a beneficial electrolyte interface layer, such as lithium fluoride (LiF), on the negative electrode surface after charging and discharging, a protective buffer layer, and forms an alloy that facilitates the deposition of dense lithium on the negative electrode current collector, significantly extending the life of the battery.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by reference to the following detailed description of the preferred embodiments and the accompanying drawings.

FIGS. 1A and 1B are flow charts of the steps of the preferred two embodiments of the method for stabilizing the electrode using a functional layer of the present invention;

FIGS. 2A and 2B are the electron micrograph of the negative electrode current collector profile of the Cu@SrF₂ embodiment during the charging and discharging of the present invention;

FIG. 3 is the overpotential nucleation analysis of the present invention and the comparative example;

FIGS. 4A and 4B are the results of the binding energy of the beneficial electrolyte interface layer grown during the charging and discharging process of the Cu@SrF₂of the present invention;

FIGS. 4C and 4D are the results of the binding energy of the electrolyte interface layer grown during charging and discharging of the comparative example;

FIGS. 5A, 5B, and 5C are the scanning electron micrograph (SEM) of the beneficial electrolyte interface layer grown during the first charging and discharging process for SrF₂-coated Cu, Cu@GNPH of the present invention and Bare Cu of the comparative example, respectively;

FIGS. 6A, 6B, and 6C are the results of areal capacity and coulombic efficiency tests after multiple charge/discharge cycles using an anode-free pouch battery with Cu@SrF₂ of the present invention and Bare Cu of the comparative example;

FIGS. 7A, 7B, and 7C are the results of voltage, areal capacity, and coulombic efficiency tests after multiple charge/discharge cycles using an anode-free lithium metal battery with Cu—Sn@SFHFP of the present invention and Bare Cu of the comparative example;

FIG. 8 is the result of the areal capacity and coulombic efficiency tests after multiple charge/discharge cycles using an anode-free lithium metal battery with Cu@GN of the present invention and Bare Cu of the comparative example; and

FIGS. 9A and 9B are the results of voltage, areal capacity, and coulombic efficiency tests after multiple charge/discharge cycles using an anode-free lithium metal battery with Cu@GNPH of the present invention and Bare Cu of the comparative example.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to.

### <Method of Stabilizing Electrode Using a Functional Layer>

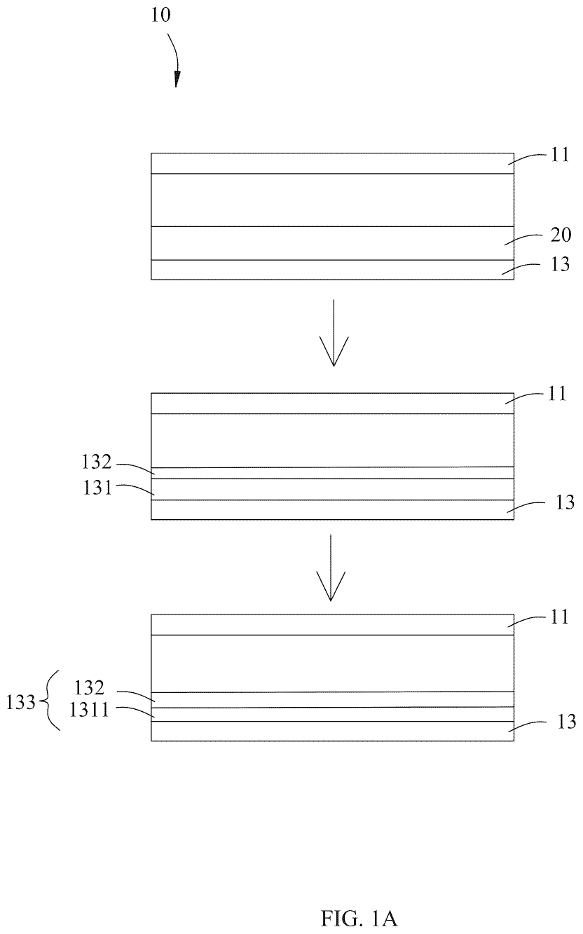

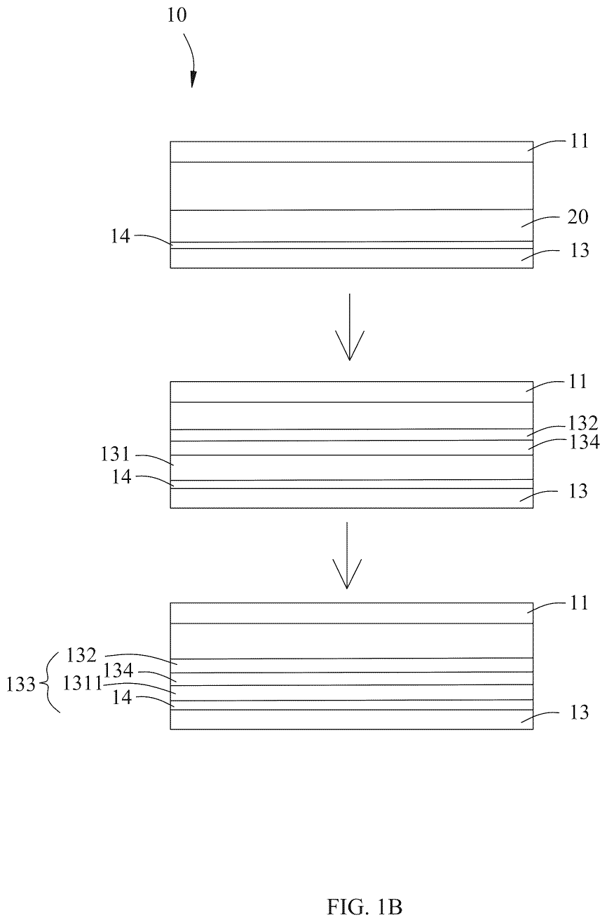

With reference to FIG. 1A, the present invention first provides a method for stabilizing electrodes using a functional layer comprising the steps of:
S1) providing a battery 10 comprising at least a positive electrode 11 and a negative electrode 13 in current/voltage communication;
S2) attaching a functional layer precursor 20 to at least a portion of the surface of the negative electrode 13;
S3) charging (or plating) the positive electrode 11 and the negative electrode 13 of the battery 10 and forming a metal/alloy layer 131 on the surface of the negative electrode 13 corresponding to the surface of the functional layer precursor 20, also forming an electrolyte interface layer 132 on the surface of the metal/alloy layer 131; and
S4) discharging (or stripping) the positive electrode 11 and the negative electrode 13 of the battery 10 so that the metal/alloy layer 131 is transformed into a functional layer 133 and the electrolyte interface layer 132.

The battery 10 is preferably a solid-state battery in the present invention where the negative electrode 13 of it is a conductive metal, such as an anode-free battery with a bare copper or aluminum current collector, and the positive electrode 11 preferably contains a positive electrode material, which may be, but is not limited to, a ternary positive electrode material (NCM).

As shown in FIG. 1A, the first preferred embodiment of the functional layer precursor 20 comprises a material with composition AₓB_{y}, where x and y are positive integers, A is a lithiophilic metal or a lithiophilic metalloid, and B is an inorganic material, which the lithiophilic metal may be, for example, strontium (Sr), gallium (Ga), antimony (Sb), magnesium (Mg), calcium (Ca), barium (Ba), scandium (Sc), yttrium (Y), aluminum (Al), indium (In), thallium (Tl), germanium (Ge), tin (Sn), lead (Pb), antimony (Sb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg) or combinations thereof; the lithiophilic metalloid may be, for example, carbon (C), silicon (S1), arsenic (As) or combinations thereof; and B is an inorganic material, an inorganic element preferably enables the negative electrode 13 to grow a desirable solid electrolyte interface (SEI) layer, such as fluorine (F), nitrogen (N), phosphorus (P), oxygen (O), sulfur (S), bromine (Br), chlorine (Cl), iodine (I), hydrogen (H) or a combination thereof. A preferred embodiment of the functional layer precursor 10 includes strontium fluoride (SrF₂) or gallium nitride (GaN).

Specifically, in the preceding Step 3 (S3) of charging or plating step, the positive electrode and the negative electrode of the battery are charged, and preferably, the negative electrode is provided with a current collector surface corresponding to composition A of the functional layer precursor AₓB_{y} to form a metal/alloy layer, preferably an alloy with lithium/lithium and composition A, and the surface of the metal/alloy layer, B, and/or an alloy compound thereof is formed an electrolyte interface layer that facilitates the conduction of lithium ions. Next, in the discharge process of Step 4(S4), the metal/alloy layer is transformed into a multi-functional layer during the discharge process comprising the electrolyte interface layers that are favorable for conducting lithium ions to protect the electrode.

With reference to FIG. 1B, the second preferred embodiment of the functional layer precursor 20 may further comprise a polymer mixed with the AₓB_{y} material, which primarily provides a buffer for the expansion of the negative electrode volume caused by the deposition of lithium metal. The polymer is preferably selected to contain at least one of the material properties of ionic conductivity, electrical conductivity, and/or porosity, or may have multiple material properties of ionic conductivity, electrical conductivity, and porosity at the same time, or maybe a porous material that is only ion conductive (but not electricity conductive), there is no limitation herein.

The polymer comprises Polyparaphenylene, Polythiophene (PT), Polyphenylene (PPO), Polyaniline (PANI), Polyacetylene, Polypyrrole (PPy), Polyacrylonitrile (PAN), Poly(Methyl Methacrylate) (PMMA), Poly(Vinyl Chloride) (PVC), Poly(ethylene oxide)(PEO), Poly(vinyl pyrrolidone) (PVP), Poly(vinyl alcohol) (PVA), Poly(caprolactone) (PCL), Ploy (chitosan), Poly(vinylpyrrolidone) (PVP), Polyvinyl difluoride (PVDF), Poly(imide) (PI), Polyvinylidene difluoride (PVDF)-Hexafluoropropylene (HFP) complexes or combinations thereof. The presence of the polymer can make the electrolyte interface layer dense and not easy to crack which can be used as a buffered bonding layer.

The third preferred embodiment of the functional layer precursor 20, based on the aforementioned second preferred embodiment, can further include another lithiophilic material layer 14 between the polymer, the mixed layer of AₓB_{y} material, and the negative electrode 13 as a second functional layer precursor to increase the affinity of the lithium metal, the lithiophilic material layer 14 contains strontium (Sr), gallium (Ga), antimony (Sb), magnesium (Mg), calcium (Ca), barium (Ba), barium (Sc), yttrium (Y), aluminum (Al), indium (In), thallium (TI), germanium (Ge), tin (Sn), lead (Pb), antimony (Sb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg), carbon (C), silicon (S1), arsenic (As) or combinations thereof.

The charging process in Step 3 (S3), the metal/alloy layer 131 transformed from the functional layer precursor 20 varies depending on the difference of the aforementioned functional layer precursor 20, forming an alloy by mixing the lithium/lithium metal and the lithiophilic metal or the lithiophilic metalloid. In terms of the first preferred embodiment of the functional layer precursor 20, the metal/alloy layer 131 may preferably be a lithium/lithium strontium alloy (Li/LiSr Alloy) or a lithium/lithium gallium alloy (Li/LiGaAlloy).

The electrolyte interface layer 132 also varies depending on the difference of the functional layer precursor 20, in terms of the first preferred embodiment of the functional layer precursor 20, the electrolyte interface layer 132 may preferably be lithium fluoride (LiF), lithium nitride (Li₃N), lithium phosphide (Li₃P), lithium oxide (Li₂O), lithium chloride (LiCl), lithium bromide (LiBr), lithium iodide (LiI), lithium hydrogen (LiH), or lithium sulfide (Li₂S).

The functional layer 133 corresponds to the difference of the aforementioned functional layer precursor 20, in terms of the first preferred embodiment of the functional layer precursor 20, the functional layer 131 is a metallic layer 1311 (e.g., metal strontium or metal gallium layer) and the electrolyte interface layer 132 formed by the lithiophilic metal. In terms of the second preferred embodiment of the functional layer precursor 20, the functional layer 131 comprises the metallic layer 1311 (e.g., metal strontium or metal gallium layer), a polymer layer 134 formed by the polymer, and the electrolyte interface layer 132. The overall thickness of the functional layer 133 provided by the present invention is preferably between 1˜20 μm.

Please refer to Table 1 below, which shows a preferred embodiment of the functional layer precursor 20 used in Step 3 (or the Lithium Plating Process) and Step 4 (or the Lithium Stripping Process), and the metal/alloy layer 131, the electrolyte interface layer 132, and the functional layer 133 formed therewith, for the present invention.

Table 1, in which the left-to-right columns represent the material types of each layer that are sequentially layered on the negative electrode 13.

| | Charging Step | | Discharging step |
|---|---|---|---|
| | (S3) (Lithium | | (S4) (Lithium |
| | Plating Process) | | Stripping Process) |
| Functional Layer | Metal/Alloy | Electrolyte | Functional |
| Precursor | Layer | Interface | Layer |
| | | Layer | |
| SrF₂ | Li/LiSr | LiF | Sr \grave{ } LiF |
| GaN | Li/LiGa | LiNx | Ga \grave{ } LiNx |
| PVDF-HFP + SrF₂ | Li/LiSr \grave{ } | LiF | Sr \grave{ } PVDF-HFP \grave{ } |
| | PVDF-HFP | | LiF |
| PVDF-HFP + GaN | Li/LiGa \grave{ } | LiNx | Ga \grave{ } PVDF-HFP \grave{ } |
| | PVDF-HFP | | LiNx |
| Sn \grave{ } PVDF-HFP + | Li/LiSr \grave{ } | LiF | Sn \grave{ } Sr \grave{ } |
| SrF₂ | LiSn \grave{ } | | PVDF-HFP \grave{ } |
| | PVDF-HFP | | LiF |

<Electrode with Functional Layer and its Battery Application>

As shown in FIGS. 1A and 1B, the present invention also provides the aforementioned electrode with the functional layer 133 generated after the discharge (Stripping Process) and its application in battery, which includes each preferred embodiment of the functional layer as shown in Table 1 above and a preferably anode-free battery.

### <Validation Tests>

The present invention uses each of the embodiments exemplified in Table 1 and the bare copper negative current collector as a comparative example (coded Bare Cu or BCu in the drawings) to conduct the following types of validation tests. Wherein, the codes of Cu@SrF₂ and SrF₂-coated Cu in the drawings are SrF₂ coated on the bare copper negative current collector, Cu@GN is GaN coated on the bare copper negative current collector, and Cu@GNPH is GaN+PVDF−HFP coated on the bare copper negative current collector.

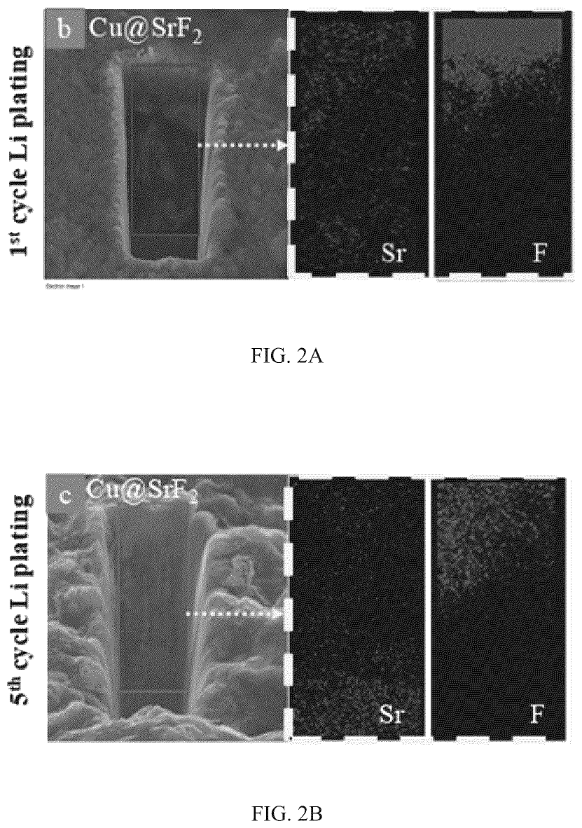

Please refer to FIGS. 2A and 2B, which are the cross-sectional electron micrograph of the negative electrode 13 in the charging and discharging process showing the embodiment of the negative electrode 13 coated Cu@SrF₂on the negative current collector of the present invention. It can be seen from FIG. 2A to FIG. 2B that Sr is gradually deposited on the negative electrode 13 during the first to fifth charge and discharge cycles, and the F element of SrF₂ can form lithium fluoride (LiF) on the surface, becoming an electrolyte interface layer (LiF-rich, 2Li⁺+SrF₂+2e⁻→Sr+2LiF) that is favorable for the conduction of lithium ions, while the Sr metal element is favorable for the generation of Li—Sr alloy, which helps to form a dense lithium metal deposit on the current collector of the negative electrode to improve the battery performance.

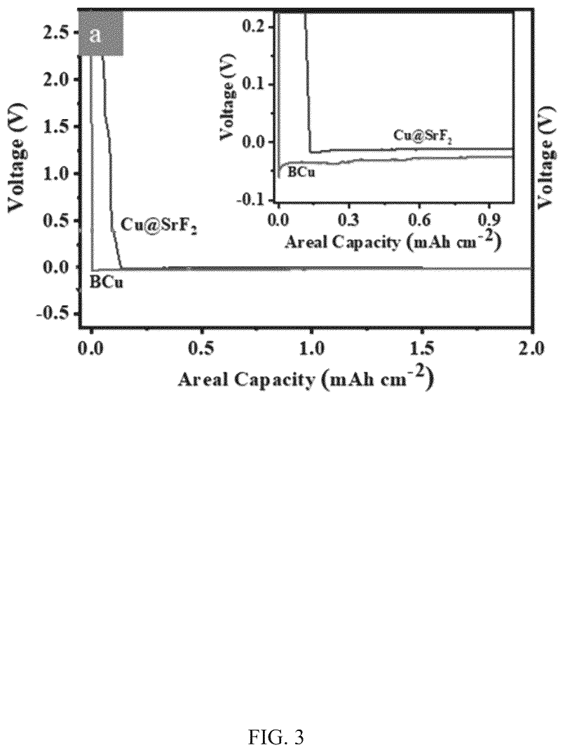

The over potential nucleation analysis (current density 0.2 mAcm-2,2 mAhcm-2 Li deposition capacity) as shown in FIG. 3, the over potential of BCu is 35.11 mV (vs. Li/Li⁺). The SrF₂-coated Cu of the present invention is only 4.92 mV, which shows a lower nucleation energy barrier and avoids the formation of dendrite lithium, and which means that the strontium metal can further form a Sr—Li alloy and facilitate the deposition of dense lithium SEI.

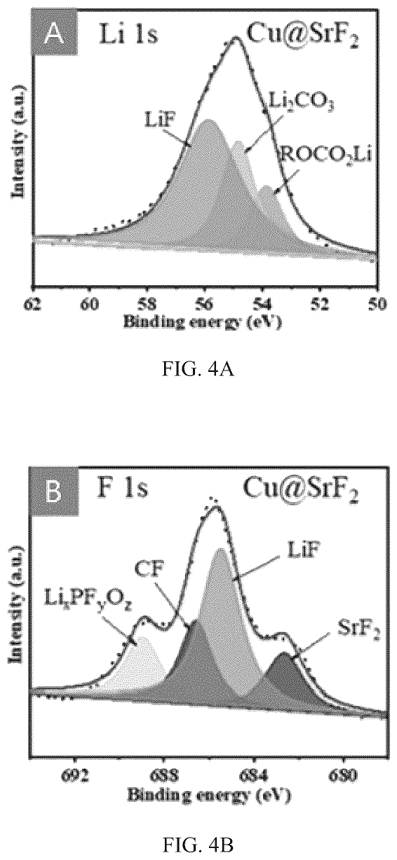

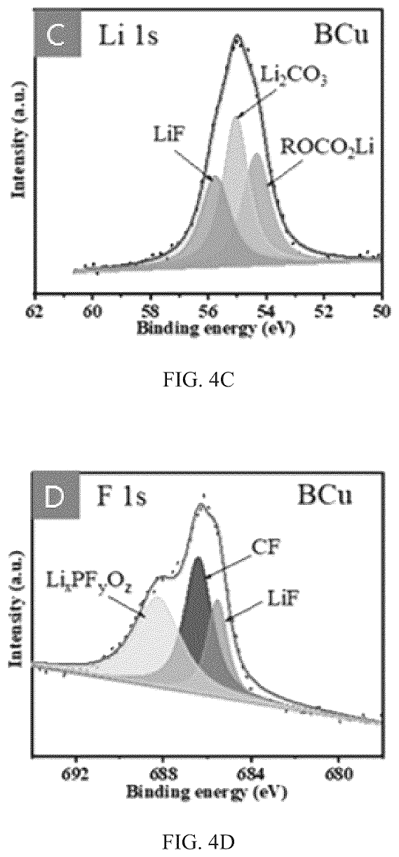

With reference to FIGS. 4A and 4B are the binding energy results of the beneficial electrolyte interface layer (LiF) grown on the negative electrode 13 where Cu@SrF₂ of the present invention coated on the negative electrode current collector as an example during the charge and discharge process, and FIGS. 4C and 4D are the binding energy results of the undesirable electrolyte interface layer (Li₂CO₃, ROCO₂Li) grown on the negative electrode 13 of the bare copper negative electrode current collector for comparative example during charging and discharging. Comparing the surface area of various electrolyte interface layers in FIGS. 4A˜4D, FIGS. 4A and 4B of the present invention show a larger area of the beneficial and highly dense electrolyte interface layer (LiF), and the area of the undesirable electrolyte interface layer (Li₂CO₃, ROCO₂Li) is significantly less than that of FIGS. 4C and 4D of the comparative example.

The present invention also combines tin, polymer PVDF-HFP, and SrF₂ (Cu—Sn@SFHFP in the drawings) coated together on the negative electrode 13, which not only has the effect of SrF₂, but also provides a polymer buffer layer to avoid the side reaction caused by the deposition of lithium in liquid or solid electrolytes, which can significantly extend the battery life.

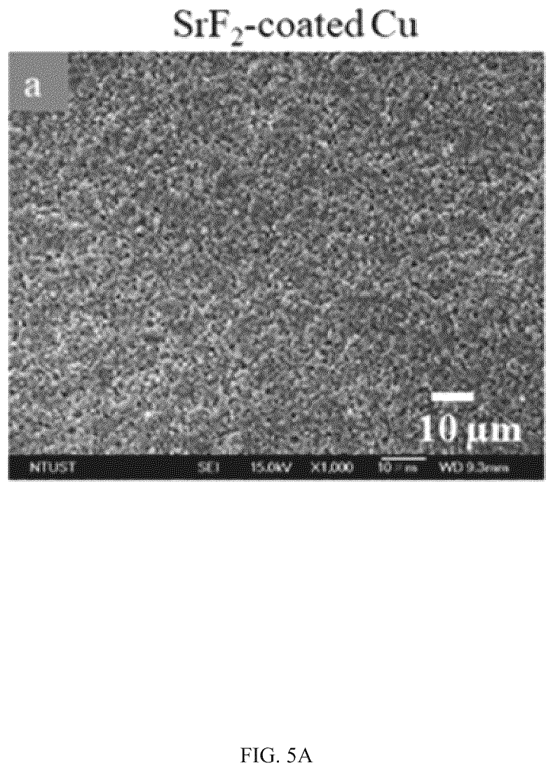

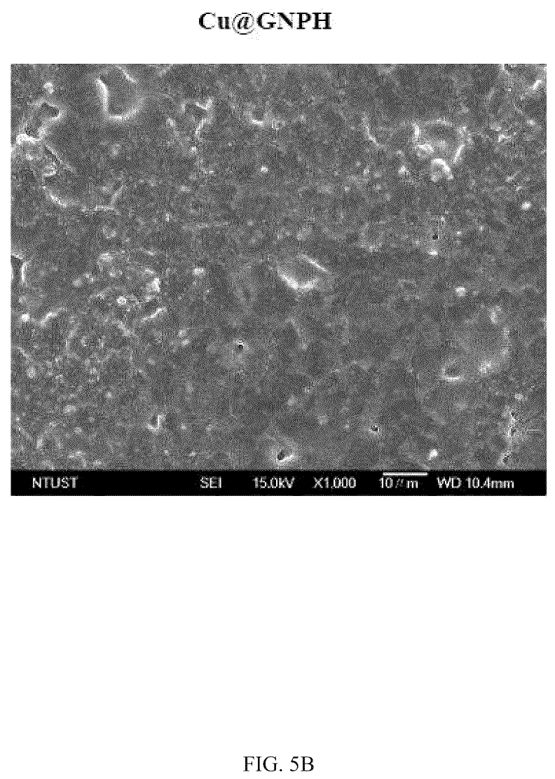

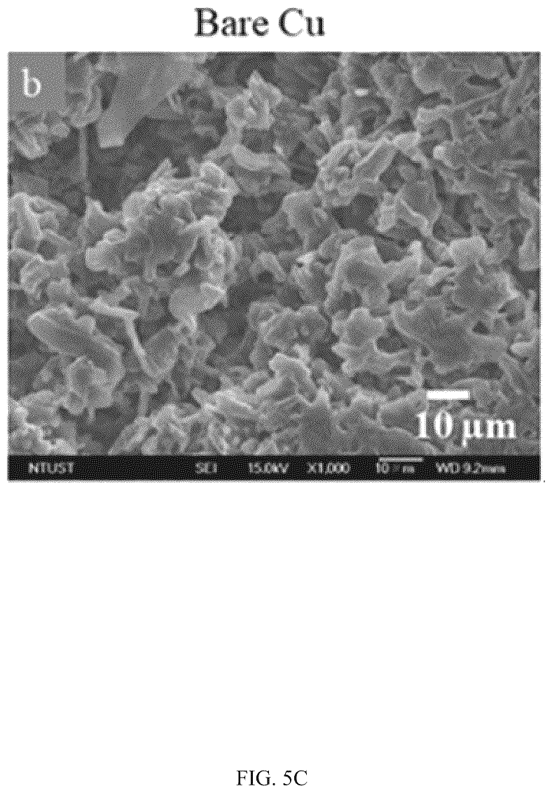

With reference to FIGS. 5A, 5B, and 5C are scanned electron micrographs (SEM) of the beneficial electrolyte interface layer SEI grown on the negative electrode of SrF₂-coated Cu, Cu@GNPH of the present invention and the Bare Cu of the comparative example during the first charging and discharging process, respectively. FIGS. 5A and 5B show that the SrF₂-coated Cu and Cu@GNPH embodiments of the present invention exhibit a highly dense and homogeneous pattern of the beneficial electrolyte interface layer SEI, while the Bare Cu of the comparative example in FIG. 5C shows an irregular blocky pattern.

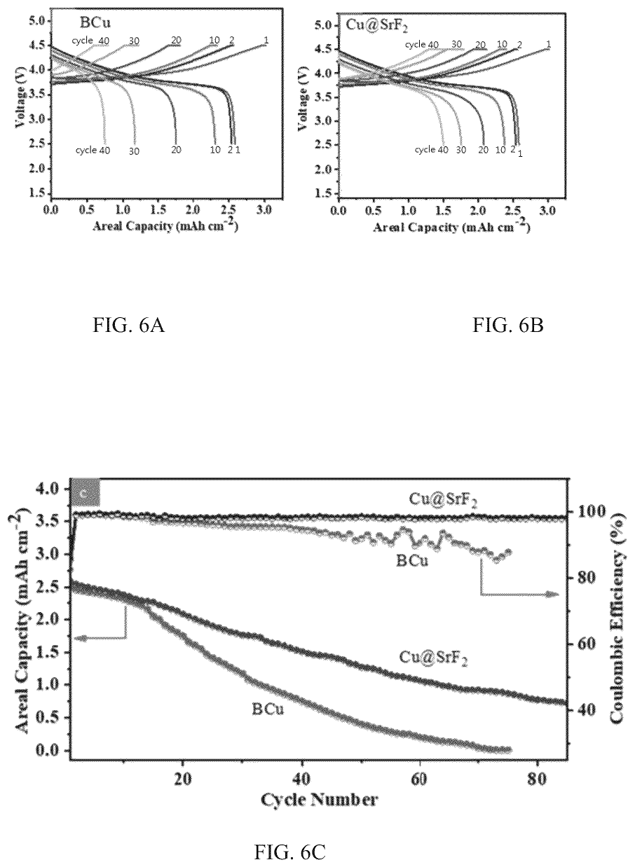

With reference to FIGS. 6A˜6C are the areal capacity and coulombic efficiency tests which show the performance of Cu@SrF₂ of the present invention and Bare Cu of the comparative example used on the anode-free pouch cell after multiple charge/discharge cycles. The areal capacity and coulombic efficiency tests of both the present invention and the comparative example are conducted with NCM positive electrode material and electrolytes 1 M LiPF₆, EC/DEC (1:1 volume), and 5% volume of FEC at 0.5 mAcm-2 current. FIG. 6A and FIG. 6B show the areal capacity and voltage tests of the present invention and the comparative example, then compare the data with the areal capacity and coulombic efficiency of the corresponding FIG. 6C. From FIG. 6C which can realize that the present invention has higher charging and discharging cycle efficiency and consistently maintains high coulombic efficiency.

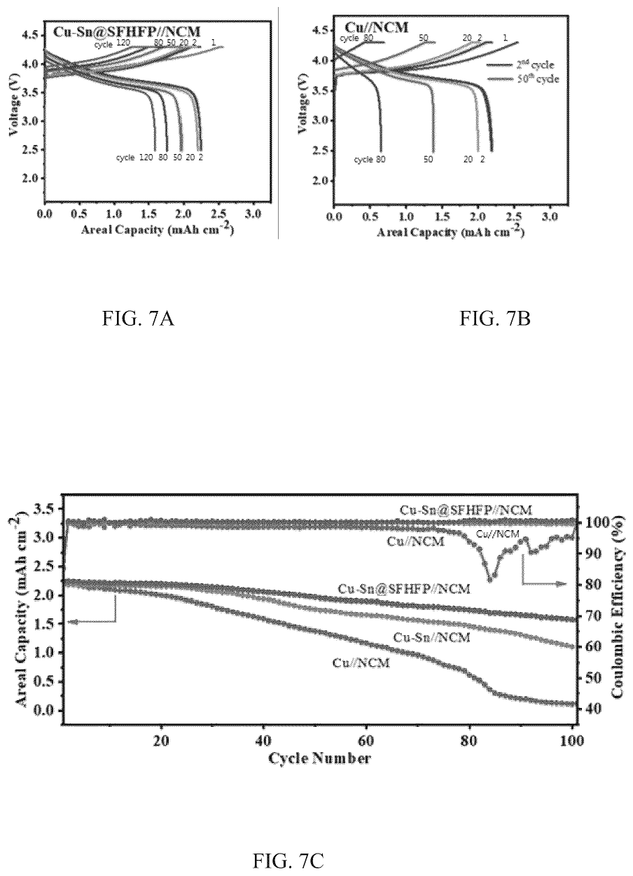

With reference to FIGS. 7A˜7C are the areal capacity and coulombic efficiency tests which show the performance of Cu—Sn@SFHFP of the present invention and Bare Cu of the comparative example used on the anode-free Li metal battery (AFLMBs) after multiple charge/discharge cycles. FIG. 7A and FIG. 7B show the areal capacity and voltage tests of the present invention and the comparative example, then compare the data with the areal capacity and coulombic efficiency of the corresponding FIG. 7C. From FIG. 7C which can realize that the present invention has higher charging and discharging cycle efficiency and consistently maintains high coulombic efficiency.

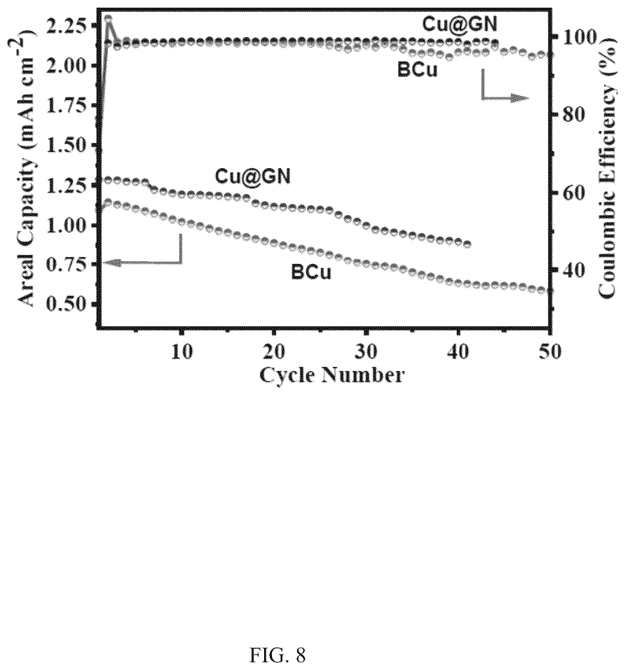

With reference to FIG. 8 is the areal capacity and coulombic efficiency tests which show the performance of Cu@GN of the present invention and Bare Cu of the comparative example used on the anode-free Li metal battery (AFLMBs) after multiple charge/discharge cycles. From the tests, it can be seen that the embodiment of the present invention is able to maintain better areal capacity and coulombic efficiency electrical performance.

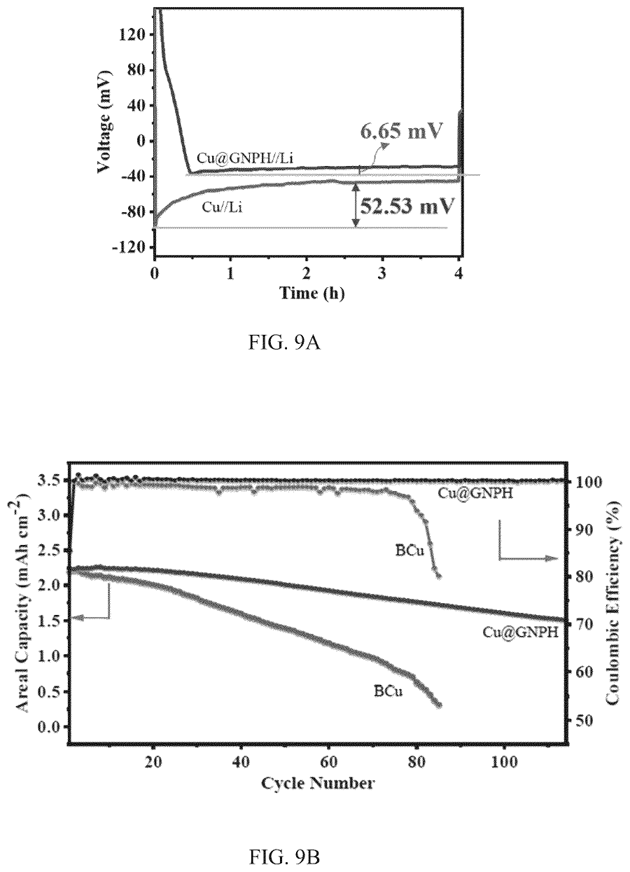

With reference to FIGS. 9A, 9B, and Table 2 below are the voltage, areal capacity, and coulombic efficiency tests which show the performance of Cu@GNPH of the present invention and Bare Cu of the comparative example used on the anode-free Li metal battery (AFLMBs) after multiple charge/discharge cycles. From the tests, it can be seen that the embodiment of the present invention is able to maintain better areal capacity and coulombic efficiency electrical performance.

TABLE 2

| | | ACE (%) | Capacity Retention |
|---|---|---|---|
| | | 100 cycles of | (%) |
| Battery Type | ICE(%) | Charge/Discharge | At 80^{th}Cycle |
| Cu//NCM | 85.49 | 98.54 | 27.9 |
| Cu@GNPH//NCM | 85.15 | 99.9 | 78.6 |

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A method for stabilizing an electrode using a functional layer comprising the steps of:
providing a battery comprising at least a positive electrode and a negative electrode in current/voltage communication;
attaching a functional layer precursor to at least a portion of the surface of the negative electrode, the functional layer precursor comprising a material with composition of AₓB_{y} and/or a polymer, where x and y are positive integers, A is a lithiophilic metal or a lithiophilic metalloid, and B is an inorganic material;
charging the positive electrode and the negative electrode of the battery and forming a metal/alloy layer on the surface of the negative electrode corresponding to the surface of the functional layer precursor and the composition A of the functional layer precursor AₓB_{y}, also forming an electrolyte interface layer on the surface of the metal/alloy layer, B, and/or its alloy compound; and
discharging the positive electrode and the negative electrode of the battery so that the metal/alloy layer is transformed into a functional layer and the electrolyte interface layer, and obtains the electrode that is stabilized by using the functional layer.

2. The method for stabilizing an electrode using a functional layer as claimed in claim 1, wherein: the negative electrode is a current collector containing a conductive metal, and the positive electrode contains a positive electrode material.

3. The method for stabilizing an electrode using a functional layer as claimed in claim 1, wherein:the polymer is aporous polymer with properties of ionic conductivity, electrical conductivity, containing Polyparaphenylene, Polythiophene (PT), Polyphenylene (PPO), Polyaniline (PANI), Polyacetylene, Polypyrrole (PPy), Polyacrylonitrile (PAN), Poly(Methyl Methacrylate)(PMMA), Poly(Vinyl Chloride) (PVC), Poly(ethylene oxide) (PEO), Poly(vinyl pyrrolidone) (PVP), Poly(vinyl alcohol) (PVA), Poly(caprolactone) (PCL), Ploy (chitosan), Poly(vinyl pyrrolidone) (PVP), Polyvinyl difluoride (PVDF), Poly(imide) (PI), Polyvinylidene difluoride (PVDF)—Hexafluoropropylene (HFP) complexes or a combination thereof.

4. The method for stabilizing an electrode using a functional layer as claimed in claim 1, wherein: the lithiophilic material layer is contained between the polymer, the AₓB_{y} material, and the negative electrode, comprising strontium (Sr), gallium (Ga), antimony (Sb), magnesium (Mg), calcium (Ca), barium (Ba), barium (Sc), yttrium (Y), aluminum (Al), indium (In), thallium (Tl), germanium (Ge), tin (Sn), lead (Pb), antimony (Sb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg), carbon (C), silicon (S1), arsenic (As) or combinations thereof.

5. The method for stabilizing an electrode using a functional layer as claimed in claim 1, wherein: the lithiophilic metal comprises strontium (Sr), gallium (Ga), antimony (Sb), magnesium (Mg), calcium (Ca), barium (Ba), barium (Sc), yttrium (Y), aluminum (Al), indium (In), thallium (Tl), germanium (Ge), tin (Sn), lead (Pb), antimony (Sb), bismuth (Bi), selenium (Se), tellurium (Te), rhodium (Rh), iridium (Ir), palladium (Pd), platinum (Pt), silver (Ag), gold (Au), zinc (Zn), cadmium (Cd), titanium (Ti), molybdenum (Mo), niobium (Nb), mercury (Hg) or combinations thereof; the lithiophilic metalloid comprises carbon (C), silicon (S1), arsenic (As) or combinations thereof; and the inorganic material comprises fluorine (F), nitrogen (N), phosphorus (P), oxygen (O), sulfur (S), bromine (Br), chlorine (Cl), iodine (I), hydrogen (H) or combinations thereof.

6. The method for stabilizing an electrode using a functional layer as claimed in claim 5, wherein: the metal/alloy layer comprises the lithium/lithium metal and the lithiophilic metal or the lithiophilic metalloid to form an alloy.

7. The method for stabilizing an electrode using a functional layer as claimed in claim 5, wherein: the electrolyte interface layer comprises lithium fluoride (LiF), lithium nitride (Li₃N), lithium phosphide (Li₃P), lithium oxide (Li₂O), lithium chloride (LiCl), lithium bromide (LiBr), lithium iodide (LiI), lithium hydrogen (LiH), or lithium sulfide (Li₂S).

8. The method for stabilizing an electrode using a functional layer as claimed in claim 6, wherein: the electrolyte interface layer comprises lithium fluoride (LiF), lithium nitride (Li₃N), lithium phosphide (Li₃P), lithium oxide (Li₂O), lithium chloride (LiCl), lithium bromide (LiBr), lithium iodide (LiI), lithium hydrogen (LiH), or lithium sulfide (Li₂S).

9. The method for stabilizing an electrode using a functional layer as claimed in claim 5, wherein: the functional layer is a metallic layer and the electrolyte interface layer formed by the lithiophilic metal; or the functional layer comprises the metallic layer, a polymer layer formed by the polymer, and the electrolyte interface layer formed by the lithiophilic metal.

10. The method for stabilizing an electrode using a functional layer as claimed in claim 6, wherein: the functional layer is a metallic layer and the electrolyte interface layer formed by the lithiophilic metal; or the functional layer comprises the metallic layer, a polymer layer formed by the polymer, and the electrolyte interface layer formed by the lithiophilic metal.

11. An electrode, comprising an electrode having the functional layer as generated in claim 1.

12. An anode-free battery, comprising an electrode having the functional layer as generated in claim 1.
